(19) United States
(12) Patent Application Publication
(10) Pub. No.: US 2023/0222073 A1
(43) Pub. Date: Jul. 13, 2023

(54) INFORMATION TERMINAL, INFORMATION TERMINAL CONTROL METHOD, INFORMATION PROCESSING DEVICE, INFORMATION PROCESSING METHOD, INFORMATION PROCESSING SYSTEM, AND COMPUTER PROGRAM

(71) Applicant: FELICA NETWORKS, INC., TOKYO (JP)

(72) Inventors: YUICHI TODAKA, TOKYO (JP); YUICHIRO FUKUDA, KANAGAWA (JP); TOSHIKAZU ABE, TOKYO (JP)

(21) Appl. No.: 18/001,503

(22) PCT Filed: Apr. 16, 2021
(86) PCT No.: PCT/JP2021/015787

§ 371 Date: Dec. 12, 2022

(30) Foreign Application Priority Data
Jun. 18, 2020 (JP) 2020-105675

(51) Int. Cl. G06F 13/16

(52) U.S. Cl. CPC G06F 13/1689; G06F 2213/0038

(57) ABSTRACT

An information terminal that uploads IC chip information to a server is provided.

The information terminal includes a reading unit that reads information from a recording medium at a first timing based on first information described in setting information, and an upload unit that uploads the information to an external device at a second timing based on second information described in the setting information. the recording medium is an IC chip built in the information terminal or an IC chip accessible from the information terminal. The reading unit reads IC chip information from the IC chip, and the upload unit uploads the IC chip information to the external device.

### TECHNICAL FIELD

The technology (hereinafter, “the present disclosure”) disclosed in the present specification relates to an information terminal and an information terminal control method that upload information recorded in a recording device such as an IC chip to a server, an information processing device and an information processing method that operate as a server and collect information uploaded from the information terminal, an information processing system including the information terminal uploading information recorded in a recording device such as an IC chip and the server collecting information uploaded from the information terminal, and a computer program.

### BACKGROUND ART

Services using an IC chip or an IC card (hereinafter, integrated into “IC chip”) have been widely spread. The IC chip is a device protected by tamper-resistant hardware, and is used as a secure element. Furthermore, use histories of various services such as electronic money are recorded in the IC chip. There is a case where it is necessary to periodically acquire and store the information recorded in the IC chip by the server. For example, in a system configuration including an information processing terminal such as a smartphone having a function of reading an IC chip and a server that manages a use history of the IC chip, reading of the IC chip by the information processing terminal and uploading to the server are generally a series of processing.

For example, when the IC chip is simultaneously read and uploaded to the server by the service application of the information processing terminal at the timing when the user operates the IC chip, the upload requests from tens of thousands of information processing terminals to the server are concentrated at the peak time, and the load on the server is expected to increase. In a transportation electronic money service application, since many operations such as payment of a fee by an IC chip and recharging to an IC chip are performed in a commuting time zone, upload requests of a server tend to concentrate in such a time zone.

When the load on the server increases, the processing response of the server deteriorates, and as a result, the response waiting time of the server and the operation waiting time of the user increase on the service application side of the information processing terminal, which may significantly affect the service quality. In order to keep the quality of service good, it is necessary to cope with the load of the server at the peak time by adding the number of servers or changing to a server with high capability. However, such a coping method increases the cost of the service.

For example, a probe data collection method for sampling and uploading information of vehicles traveling in a specific area has been proposed (see Patent Document 1). This probe data collection method is applied to a system including a large number of vehicles and a server that collects probe data from each vehicle, manages a client as an upload source by a vehicle ID, and manages the client by using a cycle timing at which each client uploads.

In addition, there has been proposed an information processing system including an IC chip, an information terminal, and a server connected to the information terminal, in which the number of transactions between the information terminal and the server is reduced, and the load of the server is reduced by a command processing sequence between the information terminal and the server capable of asynchronously executing a processing request from the server to the information terminal (see Patent Document 2).

Furthermore, an information processing system that provides a user with a service related to a benefit provided by using data stored in an information processing terminal having a non-contact communication function has been proposed (see Patent Document 3), but it does not reduce the load on the server due to the concentration of upload.

### CITATION LIST

### Patent Document

Patent Document 1: WO 2017/037784 A

Patent Document 2: Japanese Patent Application Laid-Open No. 2007-86957

Patent Document 3: Japanese Patent Application Laid-Open No. 2011-59737

### SUMMARY OF THE INVENTION

### Problems to be Solved by the Invention

An object of the present disclosure is to provide an information terminal and an information terminal control method that upload information recorded in a recording device such as an IC chip to a server while relaxing the concentration of requests, an information processing device and an information processing method that operate as a server and collect information from the information terminal while relaxing the concentration of upload requests, an information processing system including the information terminal that uploads information recorded in the recording device such as an IC chip and a server that collects information from the information terminal while relaxing the concentration of upload requests, and a computer program.

### Solutions to Problems

The present disclosure has been made in view of the above problems, and a first aspect thereof is an information terminal including:

a reading unit that reads information from a recording medium at a first timing based on first information described in setting information; and

an upload unit that uploads the information to an external device at a second timing based on second information described in the setting information.

The setting information includes the first information in which the first timing assigned for each group classified on the basis of identification information is described and the second information in which the second timing assigned for the each group is described Then, the reading unit specifies the first timing assigned to a group corresponding to the identification information held by the information terminal from the first information, and

the upload unit specifies the second timing assigned to the group corresponding to the identification information held by the information terminal from the second information.

In addition, a second aspect of the present disclosure is an information terminal control method including:

a reading step of reading information from a recording medium at a first timing based on first information described in setting information in an information terminal; and

an upload step of uploading the information to an external device at a second timing based on second information described in the setting information in the information terminal.

Further, a third aspect of the present disclosure is an information processing device including:

a holding unit that holds setting information that describes first information for calculating a first timing at which each information terminal reads information from a recording medium and second information for calculating a second timing at which each information terminal uploads the information to a server;

an analysis unit that analyzes a situation in which the each information terminal uploads the information to the server according to the setting information; and

an update unit that updates the setting information on the basis of the analysis result.

The setting information includes the first information describing the first timing assigned for each group classified on the basis of identification information held by each information terminal and the second information describing the second timing assigned for the each group.

The analysis unit counts an upload request number for each group in a predetermined evaluation period. Then, the update unit updates the second information so that a group having a large upload request number is in a longer time zone or an upload request number at the second timing assigned to each group is smoothed.

Furthermore, a fourth aspect of the present disclosure is an information processing method, including the steps of:

distributing setting information describing first information for calculating a first timing at which each information terminal reads information from a recording medium and second information for calculating a second timing at which each information terminal uploads the information to a server;

analyzing a status in which the each information terminal uploads the information to the server according to the setting information; and

updating the setting information on the basis of the analysis result.

Furthermore, a fifth aspect of the present disclosure is an information processing system including: an information terminal that reads information from a recording medium; and a server that collects the information from each information terminal,

in which the information terminal reads the information from the recording medium at a first timing calculated on the basis of first information described in setting information distributed from the server, and uploads the information to the server at a second timing calculated on the basis of second information described in the setting information, and

the server analyzes a situation in which the each information terminal uploads the information to the server according to the setting information, and updates the setting information on the basis of the analysis result.

However, the term “system” as used herein refers to a logical assembly of a plurality of devices (or functional modules that implement specific functions), and it does not matter whether or not each device or each functional module is in a single housing.

Furthermore, a sixth aspect of the present disclosure is a computer program written in a computer-readable form so as to cause a computer to function as:

a reading unit that reads information from a recording medium at a first timing based on first information described in setting information; and

an upload unit that uploads the information to an external device at a second timing based on second information described in the setting information.

The computer program according to the sixth aspect of the present disclosure defines a computer program written in a computer-readable form so as to realize predetermined processing on a computer. In other words, by installing the computer program according to the sixth aspect of the present disclosure in a computer, a cooperative action is exerted on the computer, and the same action and effect as those of the information terminal according to the first aspect of the present disclosure can be obtained.

### Effects of the Invention

According to the present disclosure, it is possible to provide an information terminal and an information terminal control method that upload information recorded in a recording device such as an IC chip to a server while relaxing the concentration of requests, an information processing device and an information processing method that operate as a server and collect information from the information terminal while relaxing the concentration of upload requests, an information processing system including the information terminal that uploads information recorded in the recording device such as an IC chip and a server that collects information from the information terminal while relaxing the concentration of upload requests, and a computer program.

Note that the effects described in the present specification are merely examples, and the effects brought by the present disclosure are not limited thereto. Furthermore, the present disclosure may further provide additional effects in addition to the above effects.

Still other objects, features, and advantages of the present disclosure will become apparent from a more detailed description based on embodiments to be described later and the accompanying drawings.

### BRIEF DESCRIPTION OF DRAWINGS

FIG. 1 is a diagram illustrating a configuration example of an information processing system 100.

FIG. 2 is a diagram illustrating an exemplary functional configuration of the information processing system 100 that implements the information processing method according to the present disclosure.

FIG. 3 is a diagram illustrating a configuration example of setting information.

FIG. 4 is a flowchart illustrating setting information update processing.

FIG. 5 is a diagram illustrating a specific example of update processing of setting information.

FIG. 6 is a diagram illustrating a specific example of update processing of setting information.

FIG. 7 is a diagram illustrating a specific example of update processing of setting information.

FIG. 8 is a diagram illustrating a specific example of update processing of setting information.

### MODE FOR CARRYING OUT THE INVENTION

Hereinafter, embodiments of the present disclosure will be described in detail with reference to the drawings in the following order.

A. System configuration

B. Server load when IC chip information is uploaded

C. Information processing method according to present disclosure

D. Setting information

E. Update processing of setting information on server side

F. Classification using application ID

### A. System Configuration

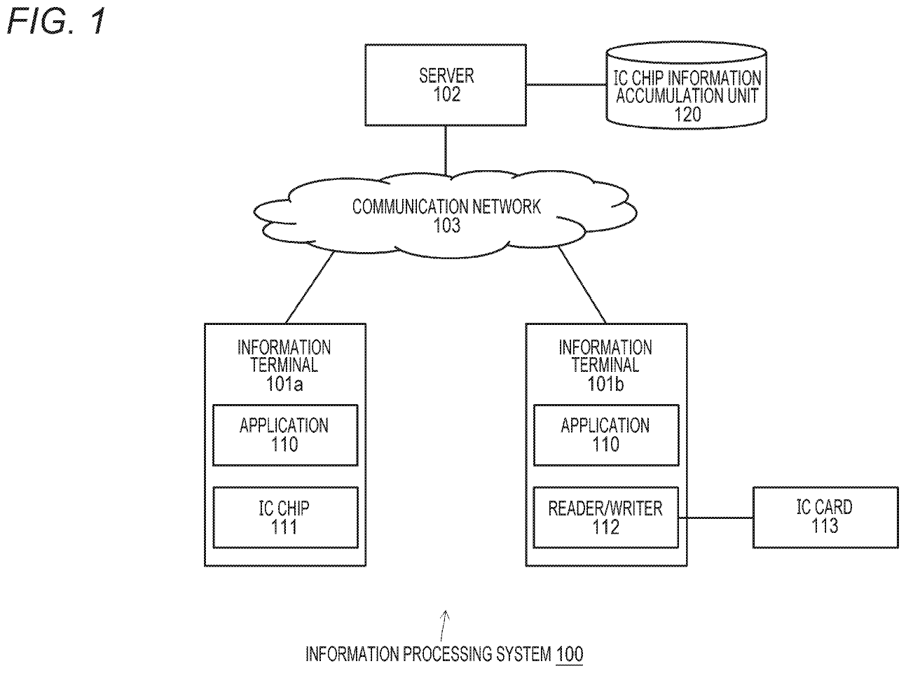

FIG. 1 schematically illustrates a configuration example of an information processing system 100 to which the present disclosure is applied. The illustrated information processing system 100 includes a server 102 and a plurality of information terminals 101a, 101b, . . . (hereinafter, also simply referred to as “information terminal 101”) connected via a communication network 103.

The information terminal 101 is, for example, a multifunctional information terminal such as a smartphone or a tablet, or a personal computer (PC), but may be a POS register, a kiosk terminal capable of downloading tickets, or the like. In the present embodiment, it is assumed that the information terminal 101 can cause an IC chip to execute predetermined processing. The information terminal 101 is roughly divided into an information terminal in which the IC chip 111 is built as indicated by a reference number 101a and an information terminal including a reader/writer 112 accessible to an external IC card 113 as indicated by a reference number 101b. Although only one information terminal 101a and one information terminal 101b are illustrated in FIG. 1 for simplification, it is assumed that a large number of information terminals 101 operate in the information processing system 100.

In the information terminal 101a, an application 110 executed on the terminal causes a processor included in a built-in IC chip to execute predetermined processing. Furthermore, in the information terminal 101b, the application 110 executed on the terminal causes a processor included in an IC chip built in the IC card 113 arranged in a range communicable with the reader/writer 112 to execute predetermined processing. In addition, the IC chip 111 securely holds a secret key corresponding to a key owned by the server 102. Therefore, the information terminal 101 that causes the IC chip 111 to execute processing can decrypt data encrypted by the server 102 and encrypt data so that the serve 102 can decrypt the data.

Here, the IC chip 111 (including an IC chip built in the IC card 113) is a secure element protected by tamper-resistant hardware. The tamper resistance includes, for example, physical tamper resistance indicating a mechanism that resists attack, tamper resistance against side channel attack that is a function of preventing information useful for estimation of internal secret information from leaking to the outside, tamper resistance that prevents internal secret information from leaking by forced malfunction from the outside, and the like. The physical tamper resistance is realized by providing a mechanism that makes it difficult to analyze an object (device, circuit board, semiconductor component, etc.), detects disassembly by some method when the object is disassembled for analysis and prevents the object from being operated, or actively erases secret information rather than leaking to the outside. The tamper resistance to side channel attack is data dependency of an encryption processing time in a device (circuit board and semiconductor integrated circuit) that processes encryption, and tamper resistance to a method of estimating secret information in the device by measuring a change in current consumption or a leaked electromagnetic wave during an encryption operation.

Note that a target on which the information terminal 101 executes the predetermined processing is not necessarily limited to the IC chip 111 having tamper resistance. For example, it may be a physical medium (memory card or the like) having tamper resistance that stores information to be kept secret on the IC chip 111. Furthermore, the information terminal 101 itself or another information terminal may be used. In that case, for example, a key is stored in a memory of the information terminal 101 or another information terminal, and a processor in the IC chip 111 performs encryption, decryption processing, and the like using the key. Therefore, in order to prevent leakage of the key and the like, at least one of the memory or the processor, desirably both of the memory and the processor, needs to have tamper resistance.

The server 104 is a computer that receives a request from the information terminal 101 and supports execution of predetermined processing by the IC chip. In the present embodiment, the server 104 manages information such as a service use history recorded in the IC chip 111 uploaded from the information terminal 101.

The communication network 103 includes, for example, a public network such as the Internet, a telephone network, or a satellite communication network, or a dedicated network such as a wide area network (WAN), a local area network (LAN), or an Internet protocol virtual private network (IP-VPN). The communication network 103 may use either wired or wireless communication media, or may be configured by combining a plurality of types of communication media including wired and wireless.

Usually, various application programs are installed in the information terminal 101. In the present embodiment, it is assumed that the information terminal 101 includes an application program (service application) 110 for causing the IC chip 111 having tamper resistance to execute predetermined processing. In addition, in the present embodiment, it is assumed that an application ID is allocated for each information terminal 101 of a distribution destination in an application program (service application) for causing the IC chip 111 to execute predetermined processing.

Here, examples of the predetermined processing executed by the application program (service application) 110 include recording of a use history of a service using information stored in the IC chip 111 in the IC chip 111, reading of the use history recorded in the IC chip 111, and uploading of the use history read from the IC chip 111 to the server 102. The server 102 includes an IC chip information accumulation unit 120 that accumulates information (hereinafter, also simply referred to as “IC chip information”) regarding the use history of the IC chip 111 uploaded from the information terminal 101.

Furthermore, the information stored in the IC chip 111 is, for example, value information such as electronic money. In this case, the application (service application) 110 corresponding to the electronic money executes processing such as recharging of the electronic money, recording of a use history of the electronic money such as payment using the electronic money in the IC chip 111, reading of the use history of the electronic money recorded in the IC chip 111, and uploading of the use history of the electronic money read from the IC chip 111 to the server 102.

### B. Server Load at the Time of Uploading IC Chip Information

The information stored in the IC chip 111 is, for example, value information such as electronic money. The user of the information terminal 101 recharges or pays electronic money using the IC chip 111, and a use history thereof is recorded in the IC chip 111. In addition, there is a case where it is necessary to periodically acquire and store the IC chip information recorded in the IC chip 111 by the server.

In the information processing system 100 as illustrated in FIG. 1, reading of the IC chip information by the information terminal 101 and uploading of the IC chip information from the information terminal 101 to the server 102 are a series of processing for storing the IC chip information in the server 102. For example, in the case of electronic money, each processing of recording the use history of electronic money in the IC chip 111, reading the use history recorded in the IC chip 111, and uploading the read use history to the server 102 is performed by the application program 110, which is a service application corresponding to electronic money, operating on the information terminal 101.

From the viewpoint of storing the IC chip information recorded on a large number of information terminals 101 in the server 102, it is desired to periodically upload the IC chip information from the information terminal 101 to the server 102. On the other hand, the memory capacity of the IC chip 111 is relatively small, and when the use history becomes full, the next use history is overwritten and recorded, and the overwritten old use history is lost. Therefore, the IC chip information needs to be read from the IC chip 111 to the information terminal 101 before being overwritten.

The IC chip information in the IC chip 111 is updated at the timing when the user operates the IC chip 111 using the information terminal 101. In order to mitigate the loss due to overwriting, for example, a method of uploading to the server 102 every time the IC chip information is updated is conceivable. However, when the service application 110 simultaneously reads the IC chip information from the IC chip 111 to the information terminal 101 and uploads the IC chip information from the information terminal 101 to the server 102 at the timing when the user operates the IC chip 111 using the information terminal 101, it is expected that the upload requests from several tens of thousands of information terminals 101 to the server 102 concentrate at the peak time and the load on the server 102 increases. For example, in a transportation electronic money service application, since a lot of operations such as payment of a fee by an IC chip and recharging to the IC chip are performed in a commuting time zone, upload requests of a server tend to concentrate in such a time zone.

When the load on the server 102 increases, the processing response of the server 102 deteriorates, and as a result, there is a concern that the response waiting time of the server 102 and the operation waiting time of the user increase on the service application 110 side of the information terminal 101, and the service quality is significantly affected. In order to keep the quality of service good, it is necessary to cope with the load of the server 102 at the peak time by adding the number of servers 102 or changing to the server 102 with high capability. However, such a coping method increases the cost of the service.

Therefore, in the present disclosure, an information processing method for reducing the load on the server 102 without taking measures such as adding the number of servers 102 or changing to the server 102 with high capability, and realizing reading of the IC chip information from the IC chip 111 to the information terminal 101 and uploading of the IC chip information from the information terminal 101 to the server 102 will be proposed below.

### C. Information Processing Method According to the Present Disclosure

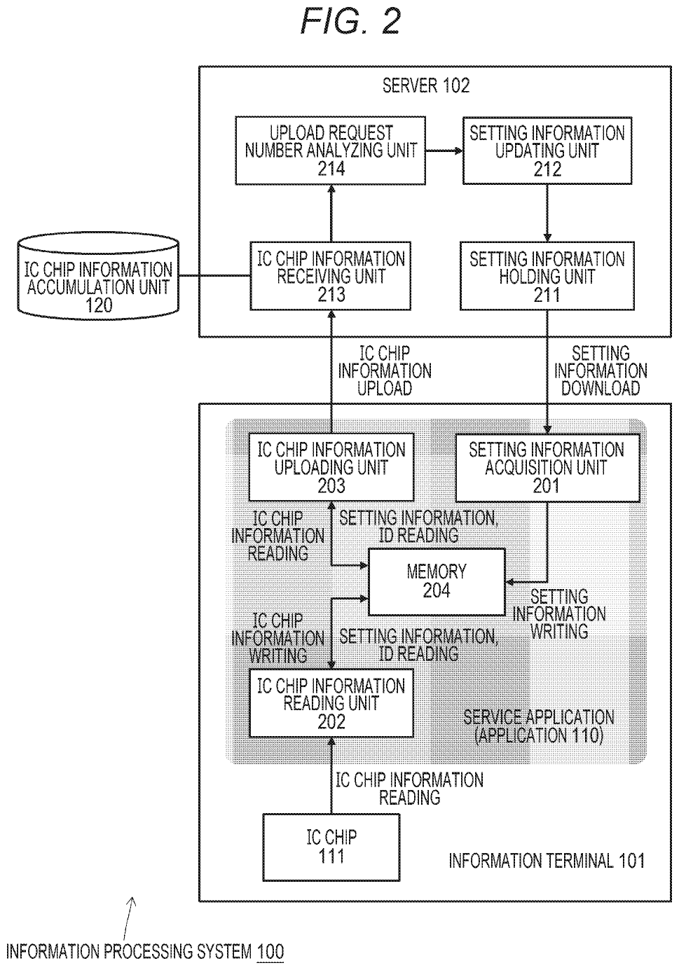

FIG. 2 schematically illustrates a functional configuration example of an information processing system 100 that implements the information processing method according to the present disclosure. In FIG. 2, for simplification of the drawing, the communication network 103 is omitted, and the information terminal 101 and the server 102 are drawn to be directly connected, but it should be understood that the communication network 103 is interposed. Furthermore, in FIG. 2, each of the information terminal 101 and the server 102 is illustrated as being limited to a functional configuration related to the information processing method according to the present disclosure, but actually, components (not illustrated) can be included as necessary.

### C-1. Configuration of Information Terminal

The information terminal 101 includes a setting information acquisition unit 201, an IC chip information reading unit 202, an IC chip information uploading unit 203, and a memory 204. These components 201 to 204 are functional modules realized by executing a service application (application 110) using the IC chip 111 on the information terminal 101. The memory 204 may be a memory area allocated for a service application in the internal memory of the information terminal 101.

Note that although FIG. 2 illustrates the information terminal 101a incorporating the IC chip 111 as an example, it should be understood that the information terminal 101b that accesses the external IC card 113 using the reader/writer 112 can similarly contribute to the information processing method according to the present disclosure only by a different method of reading the IC chip information.

The setting information acquisition unit 201 downloads the setting information from the server 102 and writes the setting information in the memory 204. Here, the setting information describes first information for calculating a first timing (time zone) at which each information terminal 101 in the information processing system 100 reads the IC chip information and second information for calculating a second timing (time zone) at which the IC chip information is uploaded. In the present embodiment, the information terminals 101 in the information processing system 100 are classified into a plurality of groups using an application ID (specifically, the end of the application ID). The setting information includes first information describing assignment of the first timing (time zone) to each group and second information describing assignment of the second timing (time zone) to each group. The server 102 updates the setting information so as to relax the concentration of upload requests, and details of the setting information will be described later.

The memory 204 is, for example, a memory area assigned for a service application in the internal memory of the information terminal 101. The memory 204 is used to store the setting information downloaded from the server 102 by the setting information acquisition unit 201, the IC chip information read from the IC chip 111 by the IC chip information reading unit 202, and other work data. Furthermore, the memory 204 also stores an application ID assigned to the service application distributed (installed) to the information terminal 101. The application ID is incorporated in, for example, the source code of the service application.

When reading the setting information and the application ID from the memory 204, the IC chip information reading unit 202 calculates a first timing (time zone) for reading the IC chip information assigned to the application ID of the own terminal on the basis of the first information described in the setting information. Then, the IC chip information reading unit 202 reads the IC chip information from the IC chip 111 at the calculated first timing (time zone) and stores the IC chip information in the memory 204.

Upon reading the setting information and the application ID from the memory 204, the IC chip information uploading unit 203 calculates a second timing (time zone) at which the IC chip information assigned to the application ID of the own terminal is uploaded to the server 102. Then, the IC chip information uploading unit 203 reads the IC chip information from the memory 204 at the calculated second timing (time zone) and requests the server 102 to upload the IC chip information.

### C-2. Configuration of Server

The server 102 includes a setting information holding unit 211, a setting information updating unit 212, an IC chip information receiving unit 213, and an upload request number analyzing unit 214.

The setting information holding unit 211 holds setting information to be distributed to the information terminal 101. The setting information describes first information for classifying a large number of information terminals 101 in the information processing system 100 into a plurality of groups and calculating a first timing (time zone) for reading IC chip information for each group, and second information for calculating a second timing (time zone) for uploading IC chip information for each group. In the present embodiment, the information terminals 101 in the information processing system 100 are classified into a plurality of groups using an application ID (specifically, the end of the application ID). The setting information includes first information describing assignment of the first timing (time zone) to each group and second information describing assignment of the second timing (time zone) to each group. Details of the setting information will be described later.

The IC chip information receiving unit 213 receives the IC chip information uploaded from the information terminal 101 and stores the IC chip information in the IC chip information accumulation unit 120. Although only one information terminal 101 is illustrated in FIG. 2, the IC chip information receiving unit 213 actually performs reception processing of the IC chip information uploaded from a large number of information terminals 101.

The upload request number analyzing unit 214 counts the upload request number from a large number of information terminals 101 in the information processing system 100 over a predetermined evaluation period, and performs analysis processing. In the present embodiment, the information terminals 101 in the information processing system 100 are classified into a plurality of groups using an application ID (specifically, the end of the application ID). Then, each information terminal 101 calculates a second timing (time zone) at which the IC chip information assigned to the application ID of the terminal is uploaded to the server 102, and requests uploading of the IC chip information to the server 102. On the other hand, the upload request number analyzing unit 214 counts the upload request number from a large number of information terminals 101 for each second timing (time zone) assigned to each group, and analyzes the degree of concentration of the upload requests of each group on the basis of the counting result. The upload request number analyzing unit 214 specifies, for example, a group having a large number of upload requests per hour (alternatively, upload requests are concentrated) or a group having a small number of upload requests per hour (alternatively, access requests are sparse).

The setting information updating unit 212 updates the description content of the setting information and writes the updated setting information in the setting information holding unit 211 such that the access request number at the second timing (time zone) assigned to each group classified on the basis of the application ID is smoothed. Specifically, on the basis of the analysis result of the upload request number analyzing unit 214, the setting information updating unit 212 extends a time zone assigned to a group having a large upload request number per hour (alternatively, upload requests are concentrated), adjusts the second timing (time zone) of each group such that the upload request number per hour is smoothed, and updates the second information of the setting information.

In short, in the information processing system 100 according to the present embodiment, the server 102 distributes the updated setting information to the information terminal 101, thereby grouping the information terminals 101 on the basis of the application ID, and controls the first timing (time zone) at which the IC chip information is read from the IC chip 111 and the second timing (time zone) at which the IC chip information is uploaded to the server 102 for each group. Therefore, the server 102 analyzes the distribution of the upload request number per time zone from the counting result over the predetermined evaluation period, adjusts the second timing (time zone) of each group such that the upload request number per hour is smoothed, and updates the second information in the setting information, thereby relaxing the concentration of upload requests on the server 102.

As a result, in the information processing system 100, an increase in the load on the server 102 can be suppressed, and deterioration of the processing response of the server 102 can be prevented. On the service application 110 side of the information terminal 101, the response waiting time of the server 102 and the operation waiting time of the user do not increase, so that the service quality can be maintained. Since it is possible to maintain good service quality by distributing the upload requests in each time zone, it is not necessary to cope with the load of the server 102 at the peak time by adding the number of servers 102 or changing to the server 102 with high capability.

### D. Setting Information

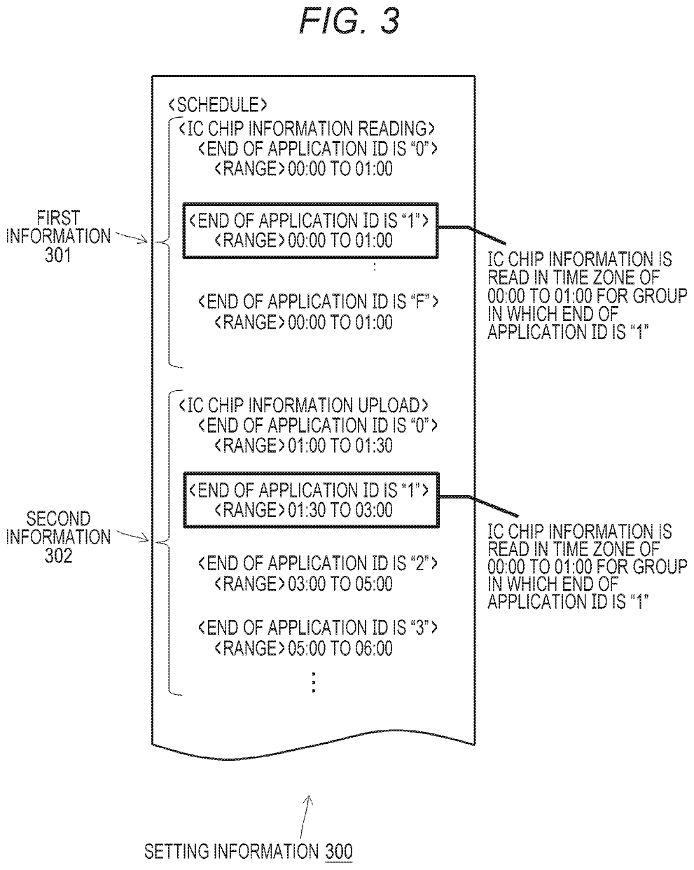

FIG. 3 illustrates a configuration example of the setting information managed on the server 102 side and distributed to the information terminal 101. FIG. 3 illustrates an example in which the setting information is described in a pseudo code format, but the setting information can be described using a predetermined structured language such as an extensible markup language (XML).

Setting information 300 illustrated in FIG. 3 includes first information 301 and second information 302. The first information 301 designates a first timing (time zone) at which the IC chip information of each group classified on the basis of the application ID is read. In addition, the second information 302 designates the second timing (time zone) of requesting the server 102 to upload the IC chip information of each group classified on the basis of the application ID.

Here, the application ID is identification information assigned for each entity of the service application, and is incorporated in, for example, the source code of the service application. The information terminal 101 stores and manages the application ID of the installed service application in the memory 204.

When reading the setting information and the application ID from the memory 204, the IC chip information reading unit 202 can calculate the group to which the own terminal belongs on the basis of the application ID and specify the first timing (time zone) assigned to the group on the basis of the first information 301 in the setting information 300.

In addition, when reading the setting information and the application ID from the memory 204, the IC chip information uploading unit 203 can calculate the group to which the own terminal belongs on the basis of the application ID, and specify the second timing (time zone) assigned to the group on the basis of the second information 302 in the setting information 300.

Referring to FIG. 3 in detail, the setting information 300 classifies the information terminals 101 into a plurality of groups using the last one digit of the application ID. Then, the first information 301 describes information in which a time zone for executing processing of reading IC chip information from the IC chip 111 is assigned to each group. In the example illustrated in FIG. 3, as the first information 301, for example, it is described that the IC chip information is read in the time zone of 00:00 to 01:00 of the day in the case of the group in which the value of the last one digit of the application ID is “0”, the IC chip information is read in the time zone of 00:00 to 01:00 of the day in the case of the group in which the value of the last one digit of the application ID is “1”, . . . , and the IC chip information is read in the time zone of 00:00 to 01:00 of the day in the case of the group in which the value of the end of the application ID is “F”. Therefore, when the own application ID of the IC chip information reading unit 202 is “1”, the IC chip information reading unit reads the IC chip information from the IC chip 111 in the time zone of 00:00 to 01:00 every day.

In addition, the second information 302 of the setting information 300 describes information in which a time zone for executing the upload request of the IC chip information is assigned for each group classified using the last one digit of the application ID. In the example illustrated in FIG. 3, as the second information 302, for example, it is described that in the case of the group in which the value of the last one digit of the application ID is “0”, the upload request of the IC chip information is made in the time zone of 01:00 to 01:30 of the day, in the case of the group in which the value of the last one digit of the application ID is “1”, the upload request of the IC chip information is made in the time zone of 01:30 to 03:00 of the day, in the case of the group in which the value of the last one digit of the application ID is “2”, the upload request of the IC chip information is made in the time zone of 03:00 to 05:00 of the day, and in the case of the group in which the value of the last one digit of the application ID is “3”, the upload request of the IC chip information is made in the time zone of 05:00 to 06:00 of the day, . . . . Therefore, when the own application ID of the IC chip information uploading unit 203 is “1”, the IC chip information uploading unit 203 requests the server 102 to upload the IC chip information in the time zone of 01:30 to 03:00 every day.

### E. Processing of Updating Setting Information on Server Side

By distributing the setting information to the information terminal 101, the server 102 can designate a first timing (time zone) at which the information terminal 101 reads the IC chip information and a second timing (time zone) at which the information terminal 101 requests the server 102 to upload the IC chip information in units of groups classified on the basis of the end of the application ID.

The server 102 can distribute the timing at which the upload request is generated in the information processing system 100 by specifying the second timing (time zone) in the setting information so as not to overlap each other for each group classified on the basis of the end of the application ID. Therefore, the server 102 can relax the concentration of upload requests by updating the second information of the setting information on the basis of a result of appropriately adjusting the time zone and the time length of the second timing for each group so that the upload requests do not concentrate in a specific time zone.

For example, it is assumed that a time zone in which the upload request number per hour is large (alternatively, upload requests are concentrated) occurs. This is because there is also a case where the number of information terminals of a part of the groups may increase if the application ID is simply classified into each group by using the value of the end of the application ID. In the present embodiment, the server 102 can smooth the access request number at the second timing assigned to each group by extending the time zone assigned to the group having a large upload request number per hour (alternatively, upload requests are concentrated) and adjusting the second timing (time zone) of each group so as to smooth the upload request number per hour, thereby relaxing the concentration of upload requests.

Each information terminal 101 calculates the second timing (time zone) assigned to the application ID of its own terminal on the basis of the latest setting information downloaded from the server 102, and makes an upload request of the IC chip information to the server 102. On the other hand, in the server 102, the upload request number analyzing unit 214 counts the upload request number over a predetermined evaluation period and performs analysis processing. Then, the upload request number analyzing unit 214 counts the upload request number from a large number of information terminals 101 for each second timing (time zone) assigned to each group, and specifies a group having a large upload request number per hour (alternatively, upload requests are concentrated) or a group having a small upload request number per hour (alternatively, access requests are sparse).

On the basis of the result analyzed by the upload request number analyzing unit 214, the setting information updating unit 212 shortens the time zone assigned to the group having a small upload request number per hour (alternatively, access requests are sparse) and extends the time zone assigned to the group having a large upload request number per hour (alternatively, upload requests are concentrated) to smooth the access request number at the second timing (time zone) assigned to each group. Then, the setting information updating unit 212 updates the second information of the setting information to description contents designating the adjusted second timing (time zone) for each group, and writes the setting information in the setting information holding unit 211. By redistributing the setting information updated in this manner to the information terminal 101 in the information processing system 100, it is possible to smooth the access request number assigned to each group at the second timing and relax the concentration of upload requests.

Note that reading of the IC chip information is internal processing of each information terminal, and there is no problem even if reading of the IC chip information occurs intensively in the same time zone in a large number of information terminals. Therefore, the server 102 may specify the end of the same application ID with the setting information such that the first timing (time zone) at which the IC chip information is read overlaps with the second timing (time zone) at which the IC chip information is requested to be uploaded. Furthermore, the server 102 does not need to perform the update processing on the first information defining the first timing (time zone) at which the IC chip information is read among the setting information.

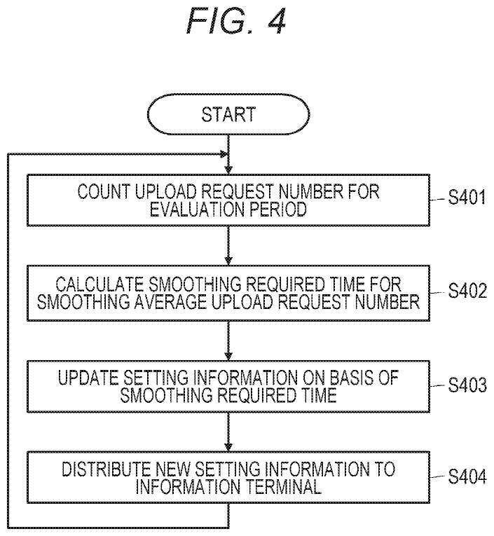

FIG. 4 illustrates setting information update processing performed in the server 102 in the form of a flowchart.

The upload request number analyzing unit 214 counts the upload request number from a large number of information terminals 101 in the information processing system 100 only for a predetermined evaluation period (step S401). The length of the evaluation period is arbitrary. The evaluation period is, for example, several days, but may be several hours or several months.

Next, the upload request number analyzing unit 214 calculates an average upload request number in each time zone assigned for each group of the information terminals 101 classified by the end of the application ID in the current setting information. On the basis of the calculation result, it is possible to specify a group having a large upload request number per hour (alternatively, upload requests are concentrated) or a group having a small upload request number per hour (alternatively, access requests are sparse). Then, the upload request number analyzing unit 214 calculates a smoothing required time for smoothing the average upload request number for each group (step S402). Specifically, the upload request number analyzing unit 214 calculates a smoothing required time for which a time zone is to be extended in order to perform smoothing for a group having a large average upload number, and calculates a smoothing required time for which a time zone is to be shortened in order to perform smoothing for a group having a small average upload request number.

Next, the setting information updating unit 212 increases or decreases the time zone of the upload request assigned to each group by the smoothing required time calculated for each group in step S402, updates the second information of the setting information to reflect the change content, and writes the second information in the setting information holding unit 211 (step S403).

Thereafter, the new setting information updated on the server 102 side is distributed to each information terminal 101 in the information processing system 100 (step S404). Specifically, the setting information acquisition unit 201 in the information terminal 101 downloads the setting information from the setting information holding unit 211 in the server 102 and writes the setting information in the memory 204.

In the information terminal 101, the IC chip information reading unit 202 reads the IC chip information from the IC chip 111 and stores the IC chip information in the memory 204 at a first timing (time zone) of reading the IC chip information assigned to the own application ID on the basis of the updated setting information. In addition, the IC chip information uploading unit 203 reads the IC chip information from the memory 204 at a first timing (time zone) of reading the IC chip information assigned to its own application ID on the basis of the updated setting information, and requests the server 102 to upload the IC chip information.

Therefore, the server 102 analyzes the distribution of the upload request number per time zone, adjusts the second timing (time zone) of each group so that the upload request number per hour is smoothed, and updates the description content of the second information in the setting information, whereby the upload requests from the information terminal 101 can be controlled not to be concentrated.

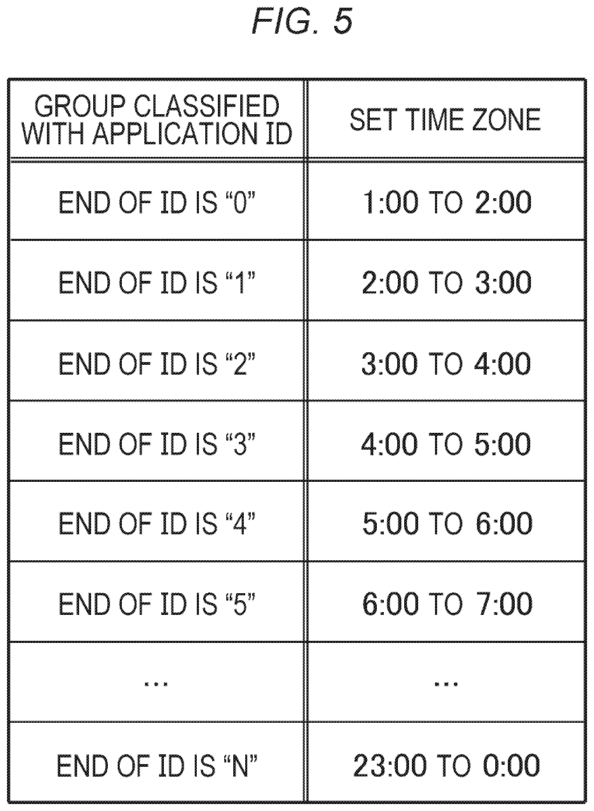

A specific example of updating the setting information in the server 102 will be described with reference to FIGS. 5 to 8. Note that, in the following description, it is assumed that the time zone of the upload request assigned according to the application ID in the setting information is updated, but the time zone in which the IC chip information is read from the IC chip 111 is not updated.

FIG. 5 illustrates a time zone of the upload request assigned to each group classified with the end of the application ID described as the second information in the current (or before update) setting information. In the example illustrated in FIG. 5, as the second information, it is described that when the value of the last one digit of the application ID is the group “0”, the upload request of the IC chip information is made in the time zone of 1:00 to 2:00 of the day, when the value of the last one digit of the application ID is the group “1”, the upload request of the IC chip information is made in the time zone of 2:00 to 3:00 of the day, when the value of the last one digit of the application ID is the group “2”, the upload request of the IC chip information is made in the time zone of 3:00 to 4:00 of the day, when the value of the last one digit of the application ID is the group “3”, the upload request of the IC chip information is made in the time zone of 4:00 to 5:00 of the day, when the value of the last one digit of the application ID is the group “4”, the upload request of the IC chip information is made in the time zone of 5:00 to 6:00 of the day, when the value of the last one digit of the application ID is the group “5”, the upload request of the IC chip information is made in the time zone of 6:00 to 7:00 of the day, . . . , and when the value of the last one digit of the application ID is the group “N”, the upload request of the IC chip information is made in the time zone of 23:00 to 0:00 of the day.

The information terminal 101 specifies a group to which the information terminal belongs on the basis of the application ID of the information terminal, and requests the server 102 to upload the IC chip information in a time zone assigned to the group. Then, on the server 102 side, the upload request number analyzing unit 214 counts and analyzes the access request number in a predetermined evaluation period for each time zone assigned to each group illustrated in FIG. 5.

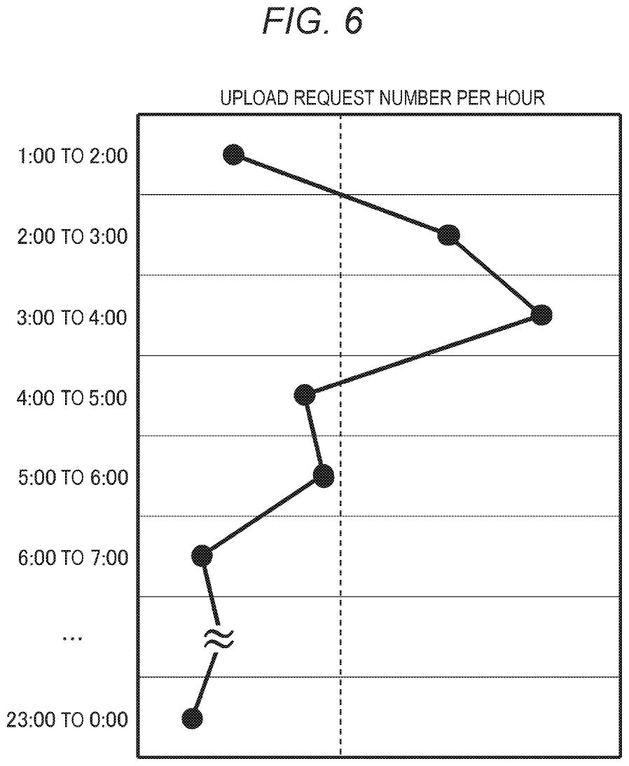

FIG. 6 illustrates the average upload request number for each time zone assigned to each group as a result of counting the access request number for each time zone over a predetermined evaluation period on the server 102 side. In the example illustrated in FIG. 6, it can be seen from the analysis result by the application request number analyzing unit 214 that the upload request number per hour in the time zone of 2:00 to 3:00 assigned to the group in which the value of the last one digit of the application ID is “1” and the time zone of 3:00 to 4:00 assigned to the group in which the value of the last one digit of the application ID is “2” protrudes from the average value of the upload request number per hour over the entire predetermined evaluation period.

Then, the upload request number analyzing unit 214 calculates a smoothing required time for smoothing the average upload request number for each group. Specifically, the upload request number analyzing unit 214 calculates a smoothing required time for which a time zone is to be extended in order to perform smoothing for a group having a large average upload number, and calculates a smoothing required time for which a time zone is to be shortened in order to perform smoothing for a group having a small average upload request number.

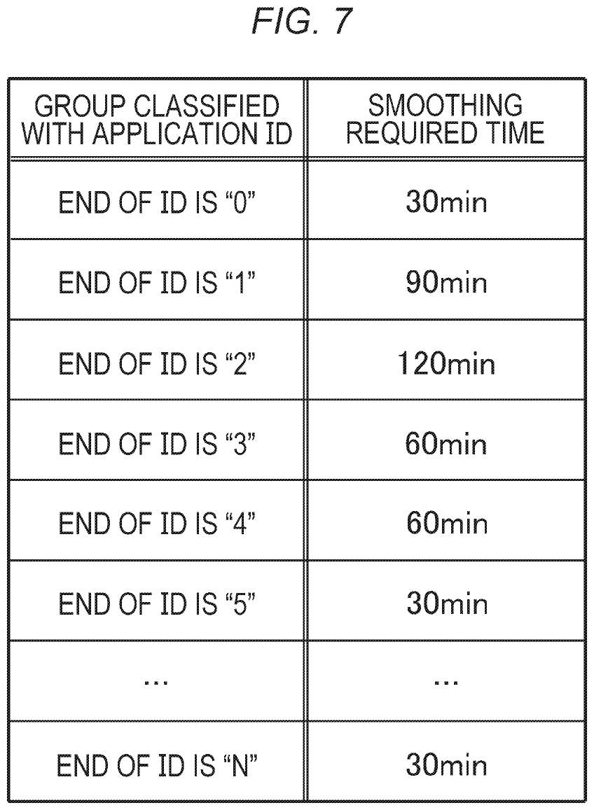

FIG. 7 illustrates a smoothing required time of each group classified with the end of the application ID, calculated by the upload request number analyzing unit 214 on the basis of the counting result illustrated in FIG. 6. In the example illustrated in FIG. 7, the smoothing required times of the group in which the value of the last one digit of the application ID is “1” and the group in which the value of the last one digit of the application ID is “2”, in which the upload request number per hour is considerably larger than the average of the entire predetermined evaluation period, are extended from the original 60 minutes to 90 minutes and 120 minutes, respectively. On the other hand, the smoothing required times of the group in which the value of the last one digit of the application ID is “0”, the group in which the value of the last one digit of the application ID is “5”, . . . , and the group in which the value of the last one digit of the application ID is “N”, in which the number of upload requests per hour is considerably smaller than the average of the entire predetermined evaluation period, are shortened from the original 60 minutes to 30 minutes, respectively.

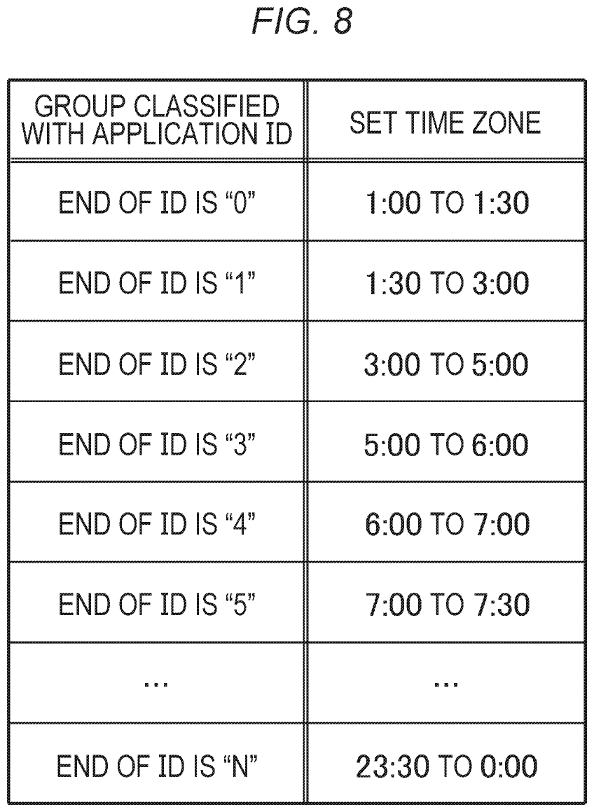

The setting information updating unit 212 increases or decreases the time zone of the upload request assigned to each group by the smoothing required time calculated for each group. FIG. 8 illustrates a time zone of the upload request of each group classified with the end of the application ID, which is re-assigned using the smoothing required time calculated on the basis of the analysis result of the upload request number over a predetermined evaluation period. In the example illustrated in FIG. 8, the time zone of the upload request assigned to the group in which the value of the last one digit of the application ID is “0” is shortened to 1:00 to 1:30, the time zone of the upload request assigned to the group in which the value of the last one digit of the application ID is “1” is extended to 1:30 to 3:00, the time zone of the upload request assigned to the group in which the value of the last one digit of the application ID is “2” is extended to 3:00 to 5:00, the time zone of the upload request assigned to the group in which the value of the last one digit of the application ID is “3” is moved to 5:00 to 6:00, and the time zone of the upload request assigned to the group in which the value of the last one digit of the application ID is “4” is moved to 6:00 to 7:00, the time zone of the upload request assigned to the group in which the value of the last one digit of the application ID is “5” is shortened to 7:00 to 7:30, . . . , and the time zone of the upload request assigned to the group in which the value of the last one digit of the application ID is “N” is shortened to 23:30 to 0:00.

Then, the setting information updating unit 212 updates the second information of the setting information so as to reflect the contents increased/decreased by the smoothing required time calculated for each group, and writes the second information in the setting information holding unit 211.

Thereafter, the setting information acquisition unit 201 in each information terminal 101 in the information processing system 100 downloads the setting information from the setting information holding unit 211 server 102 in the server 102, and writes the setting information in the memory 204. Then, each information terminal 101 reads the IC chip information from the IC chip 111 and requests uploading the IC chip information to the server 102 at the first timing (time zone) and the second timing (time zone) based on the description of the updated setting information, respectively.

Therefore, the server 102 analyzes the distribution of the upload request number per time zone, adjusts the second timing (time zone) of each group so that the upload request number per hour is smoothed, and updates the second information in the setting information, whereby the upload requests from the information terminal 101 can be controlled not to be concentrated.

### F. Classification Using Application ID

In the above description, the embodiment has been described in which the information terminal 101 in the information processing system 100 is classified for each end of the application ID, and the timing (time zone) at which the upload is requested and the timing (time zone) at which the IC chip information is read from the IC chip 111 are assigned. However, the information terminal 101 may be classified using (for example, head, any single digit or multiple digits) other than the end of the application ID, or the information terminal 101 may be classified using information other than the application ID.

### INDUSTRIAL APPLICABILITY

The present disclosure has been described in detail above with reference to specific embodiments. However, it is obvious that those skilled in the art can make modifications and substitutions of the embodiments without departing from the gist of the present disclosure.

In the present specification, the embodiment in which the present disclosure is applied to the information processing system that aggregates the IC chip information of each information terminal on the server side has been mainly described, but the gist of the present disclosure is not limited thereto. For example, the present disclosure can be similarly applied to various types of information processing systems that upload and aggregate processing results of applications for each client to a server.

In short, the present disclosure has been described in the form of exemplification, and the contents described in the present specification should not be interpreted in a limited manner. In order to determine the gist of the present disclosure, the claims should be taken into consideration.

Note that the present disclosure can also have the following configurations.

(1) An information terminal including:

a reading unit that reads information from a recording medium at a first timing based on first information described in setting information; and

an upload unit that uploads the information to an external device at a second timing based on second information described in the setting information.

(2) The information terminal according to (1),

in which the recording medium is an IC chip built in the information terminal or an IC chip accessible from the information terminal,

the reading unit reads IC chip information from the IC chip, and

the upload unit uploads the IC chip information to the external device.

(3) The information terminal according to (1) or (2), further including

a setting information acquisition unit that acquires the setting information from the external device.

(4) The information terminal according to any one of (1) to (3),

in which the setting information includes the first information in which the first timing assigned for each group classified on the basis of identification information is described and the second information in which the second timing assigned for the each group is described,

the reading unit specifies the first timing assigned to a group corresponding to the identification information held by the information terminal from the first information, and

the upload unit specifies the second timing assigned to the group corresponding to the identification information held by the information terminal from the second information.

(5) The information terminal according to (4),

in which the recording medium is an IC chip, and

the identification information is an application ID of an application using the IC chip.

(6) An information terminal control method including:

a reading step of reading information from a recording medium at a first timing based on first information described in setting information in an information terminal; and

an upload step of uploading the information to an external device at a second timing based on second information described in the setting information in the information terminal.

(7) An information processing device including:

a holding unit that holds setting information that describes first information for calculating a first timing at which each information terminal reads information from a recording medium and second information for calculating a second timing at which each information terminal uploads the information to a server;

an analysis unit that analyzes a situation in which the each information terminal uploads the information to the server according to the setting information; and

an update unit that updates the setting information on the basis of the analysis result.

(8) The information processing device according to (7),

in which the recording medium is an IC chip built in the each information terminal or an IC chip accessible from the each information terminal, and

the setting information describes the first information for calculating the first timing at which the each information terminal reads IC chip information from the IC chip and the second information for calculating the second timing at which the each information terminal uploads the IC chip information to a server.

(9) The information processing device according to (7) or (8),

in which the setting information includes the first information describing the first timing assigned for each group classified on the basis of identification information held by each information terminal and the second information describing the second timing assigned for the each group.

(10) The information processing device according to (9),

in which the recording medium is an IC chip, and

the identification information is an application ID of an application using the IC chip in each information terminal.

(11) The information processing device according to (9) or (10),

in which the analysis unit counts an upload request number for each group in a predetermined evaluation period, and

the update unit updates the second information so that a group having a large upload request number is in a longer time zone or an upload request number at the second timing assigned to each group is smoothed.

(12) An information processing method, including the steps of:

distributing setting information describing first information for calculating a first timing at which each information terminal reads information from a recording medium and second information for calculating a second timing at which each information terminal uploads the information to a server;

analyzing a status in which the each information terminal uploads the information to the server according to the setting information; and

updating the setting information on the basis of the analysis result.

(13) An information processing system including: an information terminal that reads information from a recording medium; and a server that collects the information from each information terminal,

in which the information terminal reads the information from the recording medium at a first timing calculated on the basis of first information described in setting information distributed from the server, and uploads the information to the server at a second timing calculated on the basis of second information described in the setting information, and

the server analyzes a situation in which the each information terminal uploads the information to the server according to the setting information, and updates the setting information on the basis of the analysis result.

(14) The information processing system according to (13),

in which the setting information includes the first information in which the first timing assigned for each group classified on the basis of identification information of the each information terminal is described and the second information in which the second timing assigned for each group is described, and

the each information terminal specifies the first timing assigned to a group corresponding to the identification information held by the own terminal from the first information, and specifies the second timing assigned to the group corresponding to the identification information held by the own terminal from the second information.

(15) The information processing system according to (14),

in which the server counts an upload request number for each group in a predetermined evaluation period, adjusts the second timing assigned to each group so that an upload request number per hour is smoothed, and updates the second information.

(16) A computer program written in a computer-readable form so as to cause a computer to function as:

a reading unit that reads information from a recording medium at a first timing based on first information described in setting information; and

an upload unit that uploads the information to an external device at a second timing based on second information described in the setting information.

### REFERENCE SIGNS LIST

100 Information processing system

101 Information terminal

102 Server

103 Communication network

110 Application program (service application)

111 IC chip

112 Reader/writer

113 IC card

201 Setting information acquisition unit

202 IC chip information reader

203 IC chip information uploading unit

204 Memory

211 Setting information holding unit

212 Setting information updating unit

213 IC chip information receiving unit

214 Upload request number analyzing unit

1. An information terminal comprising:
a reading unit that reads information from a recording medium at a first timing based on first information described in setting information; and
an upload unit that uploads the information to an external device at a second timing based on second information described in the setting information.

2. The information terminal according to claim 1,
wherein the recording medium is an IC chip built in the information terminal or an IC chip accessible from the information terminal,
the reading unit reads IC chip information from the IC chip, and
the upload unit uploads the IC chip information to the external device.

3. The information terminal according to claim 1, further comprising
a setting information acquisition unit that acquires the setting information from the external device.

4. The information terminal according to claim 1,
wherein the setting information includes the first information in which the first timing assigned for each group classified on a basis of identification information is described and the second information in which the second timing assigned for the each group is described,
the reading unit specifies the first timing assigned to a group corresponding to the identification information held by the information terminal from the first information, and
the upload unit specifies the second timing assigned to the group corresponding to the identification information held by the information terminal from the second information.

5. The information terminal according to claim 4,
wherein the recording medium is an IC chip, and
the identification information is an application ID of an application using the IC chip.

6. An information terminal control method comprising:
a reading step of reading information from a recording medium at a first timing based on first information described in setting information in an information terminal; and
an upload step of uploading the information to an external device at a second timing based on second information described in the setting information in the information terminal.

7. An information processing device comprising:
a holding unit that holds setting information that describes first information for calculating a first timing at which each information terminal reads information from a recording medium and second information for calculating a second timing at which each information terminal uploads the information to a server;
an analysis unit that analyzes a situation in which the each information terminal uploads the information to the server according to the setting information; and
an update unit that updates the setting information on a basis of the analysis result.

8. The information processing device according to claim 7,
wherein the recording medium is an IC chip built in the each information terminal or an IC chip accessible from the each information terminal, and
the setting information describes the first information for calculating the first timing at which the each information terminal reads IC chip information from the IC chip and the second information for calculating the second timing at which the each information terminal uploads the IC chip information to a server.

9. The information processing device according to claim 7,
wherein the setting information includes the first information describing the first timing assigned for each group classified on a basis of identification information held by each information terminal and the second information describing the second timing assigned for the each group.

10. The information processing device according to claim 9,
wherein the recording medium is an IC chip, and
the identification information is an application ID of an application using the IC chip in each information terminal.

11. The information processing device according to claim 9,
wherein the analysis unit counts an upload request number for each group in a predetermined evaluation period, and
the update unit updates the second information so that a group having a large upload request number is in a longer time zone or an upload request number at the second timing assigned to each group is smoothed.

12. An information processing method, comprising the steps of:
distributing setting information describing first information for calculating a first timing at which each information terminal reads information from a recording medium and second information for calculating a second timing at which each information terminal uploads the information to a server;
analyzing a status in which the each information terminal uploads the information to the server according to the setting information; and
updating the setting information on a basis of the analysis result.

13. An information processing system comprising: an information terminal that reads information from a recording medium; and a server that collects the information from each information terminal,
wherein the information terminal reads the information from the recording medium at a first timing calculated on a basis of first information described in setting information distributed from the server, and uploads the information to the server at a second timing calculated on a basis of second information described in the setting information, and
the server analyzes a situation in which the each information terminal uploads the information to the server according to the setting information, and updates the setting information on a basis of the analysis result.

14. The information processing system according to claim 13,
wherein the setting information includes the first information in which the first timing assigned for each group classified on a basis of identification information of the each information terminal is described and the second information in which the second timing assigned for each group is described, and
the each information terminal specifies the first timing assigned to a group corresponding to the identification information held by the own terminal from the first information, and specifies the second timing assigned to the group corresponding to the identification information held by the own terminal from the second information.

15. The information processing system according to claim 14,
wherein the server counts an upload request number for each group in a predetermined evaluation period, adjusts the second timing assigned to each group so that an upload request number per hour is smoothed, and updates the second information.

16. A computer program written in a computer-readable form so as to cause a computer to function as:
a reading unit that reads information from a recording medium at a first timing based on first information described in setting information; and
an upload unit that uploads the information to an external device at a second timing based on second information described in the setting information.
